(19) United States
(12) Patent Application Publication
(10) Pub. No.: US 2018/0282520 A1
(43) Pub. Date: Oct. 4, 2018

(54) POLYCARBONATE COMPOSITIONS COMPRISING PHOTOCHROMIC DYES

(71) Applicant: Sabic Global Technologies B.V., Bergen op Zoom (NL)

(72) Inventors: Fabrizio Micciche, Bergen op Zoom (NL); Vaidyanath Ramakrishnan, Bergen op Zoom (NL); Hendrikus Petrus Cornelis van Heerbeek, Bergen op Zoom (NL)

(21) Appl. No.: 15/531,149

(22) PCT Filed: Nov. 24, 2015
(86) PCT No.: PCT/IB2015/059055

§ 371 Date: May 26, 2017

Related U.S. Application Data
(60) Provisional application No. 62/084,381, filed on Nov. 25, 2014.

(51) Int. Cl. C08K 5/357; C08K 5/1545; C08L 69/00; B29C 45/00

(52) U.S. Cl. CPC C08K 5/357; C08K 5/1545; B29K 2069/00; B29C 45/0001; C08L 69/005

(57) ABSTRACT

Polycarbonate blend compositions are disclosed. The compositions include at least one polycarbonate and one photochromic dye. The compositions can include at least one poly(aliphatic ester)-polycarbonate. The compositions can be used to prepare articles of manufacture.

### CROSS REFERENCE TO RELATED APPLICATIONS

This application claims priority to U.S. Provisional Application No. 62/084,381, filed Nov. 25, 2014, which is herein incorporated by reference in its entirety.

### TECHNICAL FIELD

The present disclosure relates generally to polycarbonate compositions comprising a photochromic dye, processes for preparing the compositions, and articles comprising the compositions.

### BACKGROUND

Methods of incorporating photochromic dyes into thermoplastic materials, such as polycarbonates, include incorporation of organic dyes throughout the molded thermoplastic material, imbibition of dye into the surface of the thermoplastic material, or the application of dye-containing coatings at the surface of the thermoplastic material. One of the most common practices to implement photochromic behaviors to molded articles, such as sunglasses, is via application of photochromic films on the surface of the molded articles, such as lenses. However, existing techniques for including organic photochromic dyes throughout thermoplastic materials, such as extrusion and injection molding, generally do not yield satisfactory results because of the high temperatures required and the inability of the organic dye to remain stable under the processing conditions. Accordingly, there exists a need for improved polycarbonate compositions that incorporate photochromic dyes and improved processes for the manufacture of articles comprising these compositions.

### SUMMARY

In one aspect, disclosed is an article comprising a thermoplastic composition comprising:

(a) a polycarbonate that includes
(i) structural units derived from:

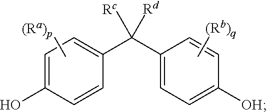

wherein R^{a} and R^{b} at each occurrence are each independently halogen, C₁-C₁₂ alkyl, C₁-C₁₂ alkenyl, C₃-C₈ cycloalkyl, or C₁-C₁₂ alkoxy; p and q at each occurrence are each independently 0 to 4; R^{c} and R^{d} are each independently hydrogen, halogen, alkyl, cycloalkyl, cycloalkylalkyl, aryl, arylalkyl, heterocyclyl, heterocyclylalkyl, heteroaryl, or heteroarylalkyl; and
(ii) structural units derived from at least one of:

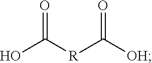

or a polydialkylsiloxane;
wherein R is C₄-C₁₈ alkyl; and

(b) a photochromic dye;

wherein the thermoplastic composition is a blend of the polycarbonate and the photochromic dye; wherein the total color shift rate of the article, ∂(dE), is at least 0.7 min⁻¹, at fifteen seconds after the article is subjected to 300 seconds of ultraviolet (UV) irradiation.

In another aspect, disclosed is an article comprising a thermoplastic composition comprising:

(a) a bisphenol-A polycarbonate, wherein a molded article of the bisphenol-A polycarbonate has transmission level greater than or equal to 90.0% at 2.5 mm thickness as measured by ASTM D1003-00 and a yellow index (YI) less than or equal to 1.5 as measured by ASTM D1925-70(1988) and

(b) a photochromic dye;

wherein the thermoplastic composition is a blend of the polycarbonate and the photochromic dye; wherein the total color shift rate of the article, ∂(dE), is at least 0.7 min⁻¹, at fifteen seconds after the article is subjected to 300 seconds of UV irradiation.

The compositions, methods, and processes of the disclosure are further described herein.

### BRIEF DESCRIPTION OF THE DRAWINGS

FIG. 1 is a bar graph showing the relationship between ∂(dE) and time after 300 sec of UV irradiation for compositions 2, 4, 6 and 8. For each timepoint, the four bars of the graph represent, from left to right, composition 4, composition 2, composition 8, and composition 6.

FIG. 2 is a graphical representation of the percent of total color fading of compositions 2 and 4 in comparison to composition 8. For each timepoint, the two bars of the graph represent, from left to right, composition 4 and composition 2.

### DETAILED DESCRIPTION

The disclosure describes polycarbonate-based blend compositions, also referred to herein as thermoplastic compositions. The compositions include at least one polycarbonate that may be a homopolymer or a copolymer, and a photochromic dye. The compositions can include one or more additional polycarbonate homopolymers or copolymers. The compositions can have improved optical properties, improved color fading properties, and improved thermal stability of the photochromic dye. In particular, the inclusion of soft block domains within the polycarbonate backbone, such as sebacic acid and/or polydimethylsiloxanes (PDMS), brings substantial improvements to the fade speed of a series of photochromic dyes.

The disclosure also describes the incorporation of the photochromic dye into the composition with limited decomposition of the dye, allowing the composition to be used as a matrix for photochromic molded articles. The coloration/decoloration response of the molded articles can be influenced by the type of polycarbonate in the composition. Accordingly, the disclosure describes a process that reduces the gamma-transition (torsional vibration of the phenyl group) or glass transition temperature (T_{g}) of the copolymer phase to improve the fading (or decoloration) speed of the manufactured article, and manufactures the article by applying proper processing conditions which lie outside the typical processing window of the polycarbonates. As such, the disclosure describes the construction of clear materials with photochromic and polycarbonate-like mechanical properties through compounding and molding or sheet/film extrusion techniques. These techniques provide an alternative to laborious and costly alternative techniques such as imbibition or coating of the thermoplastic plastic articles.

### 1. Definition of Terms

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s).” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising.” “consisting of” and “consisting essentially of,” the embodiments or elements presented herein, whether explicitly set forth or not.

The conjunctive term “or” includes any and all combinations of one or more listed elements associated by the conjunctive term. For example, the phrase “an apparatus comprising A or B” may refer to an apparatus including A where B is not present, an apparatus including B where A is not present, or an apparatus where both A and B are present. The phrases “at least one of A, B, . . . and N” or “at least one of A, B, . . . N, or combinations thereof” are defined in the broadest sense to mean one or more elements selected from the group comprising A, B, . . . and N, that is to say, any combination of one or more of the elements A, B, . . . or N including any one element alone or in combination with one or more of the other elements which may also include, in combination, additional elements not listed.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

### 2. Polycarbonate Blend Compositions

Disclosed are polycarbonate-based blend compositions. The compositions include at least one polycarbonate. The polycarbonate may be a polysiloxane-polycarbonate copolymer. The polycarbonate may be a poly(aliphatic ester)-polycarbonate copolymer. The polycarbonate may be a polycarbonate homopolymer. The compositions include at least one photochromic dye. The compositions may include at least one additional polycarbonate. The additional polycarbonate may be a poly(aliphatic ester)-polycarbonate copolymer. The compositions may further include an additional homopolymer polycarbonate. The compositions may include one or more additives.

A. Polycarbonates

The compositions include at least one polycarbonate. Polycarbonates of the disclosed blend compositions may be homopolycarbonates, copolymers comprising different moieties in the carbonate (referred to as “copolycarbonates”), copolymers comprising carbonate units and other types of polymer units such as polysiloxane units, polyester units, and combinations thereof.

The polycarbonates may include identical or different repeating units derived from one or more monomers (e.g., a second, third, fourth, fifth, sixth, etc., other monomer compound). The monomers of the polycarbonate may be randomly incorporated into the polycarbonate. For example, a polycarbonate copolymer may be arranged in an alternating sequence following a statistical distribution, which is independent of the mole ratio of the structural units present in the polymer chain. A random polycarbonate copolymer may have a structure, which can be indicated by the presence of several block sequences (I—I) and (O—O) and alternate sequences (I—O) or (O—I), that follow a statistical distribution. In a random x:(1-x) copolymer, wherein x is the mole percent of a first monomer(s) and 1-x is the mole percent of the monomers, one can calculate the distribution of each monomer using peak area values determined by ¹³C NMR, for example.

A polycarbonate copolymer may have alternating I and O units (—I—O—I—O—I—O—I—O—), or I and O units arranged in a repeating sequence (e.g. a periodic copolymer having the formula: (I—O—I—O—O—I—I—I—I—O—O—O)n). The polycarbonate copolymer may be a statistical copolymer in which the sequence of monomer residues follows a statistical rule. For example, if the probability of finding a given type monomer residue at a particular point in the chain is equal to the mole fraction of that monomer residue in the chain, then the polymer may be referred to as a truly random copolymer. The polycarbonate copolymer may be a block copolymer that comprises two or more homopolymer subunits linked by covalent bonds (—I—I—I—I—O—O—O—O—). The union of the homopolymer subunits may require an intermediate non-repeating subunit, known as a junction block. Block copolymers with two or three distinct blocks are called diblock copolymers and triblock copolymers, respectively.

(i) Homopolycarbonates/Copolycarbonates

The compositions may include one or more homopolycarbonates or copolycarbonates. The term “polycarbonate” and “polycarbonate resin” refers to compositions having repeating units of formula (1):

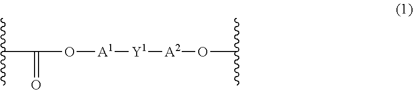

wherein each of the A¹ and A² is a monocyclic divalent aryl group and Y¹ is a bridging group having one or two atoms that separate A¹ and A². For example, one atom may separate A¹ from A², with illustrative examples of these groups including —O—, —S—, —S(O)—, —S(O)₂—, —C(O)—, methylene, cyclohexyl-methylene, 2-[2.2.1]-bicycloheptylidene, ethylidene, isopropylidene, neopentylidene, cyclohexylidene, cyclopentadecyclidene, cyclododecylidene, and adamantylidene. The bridging group of Y¹ may be a hydrocarbon group such as methylene, cyclohexylidene, or isopropylidene.

The repeating units of formula (1) may be derived from a dihydroxy monomer unit of formula (2):

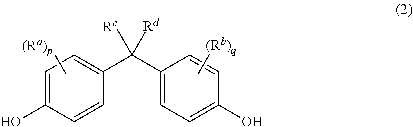

wherein R^{a} and R^{b} at each occurrence are each independently halogen, C₁-C₁₂ alkyl, C₁-C₁₂ alkenyl, C₃-C₈ cycloalkyl, or C₁-C₁₂ alkoxy; p and q at each occurrence are each independently 0 to 4; R^{c} and R^{d} are each independently hydrogen, halogen, alkyl, cycloalkyl, cycloalkylalkyl, aryl, arylalkyl, heterocyclyl, heterocyclylalkyl, heteroaryl, or heteroarylalkyl;

Exemplary monomers for inclusion in the polycarbonate include, but are not limited to, 4,4′-dihydroxybiphenyl, 1,1-bis(4-hydroxyphenyl)methane, bis(4-hydroxyphenyl)acetonitrile, bis(4-hydroxyphenyl)phenylmethane, bis(4-hydroxyphenyl)-1-naphthylmethane, 1,1-bis(4-hydroxyphenyl)ethane, 1,2-bis(4-hydroxyphenyl)ethane, 1,1-bis(4-hydroxyphenyl)-1-phenylethane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 1,1-bis(4-hydroxyphenyl)propane, 1,1-bis(4-hydroxy-t-butylphenyl)propane, 2,2-bis(4-hydroxyphenyl)propane (“bisphenol-A” or “BPA”), 2-(4-hydroxyphenyl)-2-(3-hydroxyphenyl)propane, 2,2-bis(4-hydroxy-2-methylphenyl)propane, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxy-3-bromophenyl)propane, 2,2-bis(4-hydroxyphenyl)hexafluoropropane, 1,1-bis(4-hydroxyphenyl)n-butane, 2,2-bis(4-hydroxyphenyl)butane, 3,3-bis(4-hydroxyphenyl)-2-butanone, 1,1-bis(4-hydroxyphenyl)isobutene, trans-2,3-bis(4-hydroxyphenyl)-2-butene, 1,6-bis(4-hydroxyphenyl)-1,6-hexanedione, 2,2-bis(4-hydroxyphenyl)octane, 1,1-bis(hydroxyphenyl)cyclopentane, 1,1-bis(4-hydroxyphenyl)cyclohexane, 1,1-bis(4-hydroxy-3-methylphenyl)cyclohexane, 1,1-bis(4-hydroxyphenyl)cyclododecane, 2,2-bis(4-hydroxyphenyl)adamantane, (alpha, alpha¹-bis(4-hydroxyphenyl)toluene, 4,4′-dihydroxybenzophenone, 2,7-dihydroxypyrene, bis(4-hydroxyphenyl)ether, ethylene glycol bis(4-hydroxyphenyl)ether, bis(4-hydroxyphenyl)sulfide, bis(4-hydroxyphenyl)sulfoxide, bis(4-hydroxyphenyl)sulfone, bis(4-hydroxyphenyl)diphenylmethane, 1,6-dihydroxynaphthalene, 2,6-dihydroxynaphthalene, 6,6′-dihydroxy-3,3,3′,3′-tetramethylspiro(bis)indane (“spirobiindane bisphenol”), 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, 2,7-dihydroxycarbazole, 2-phenyl-3,3-bis(4-hydroxyphenyl)phthalimidine (also referred to as 3,3-bis(4-hydroxyphenyl)-2-phenylisoindolin-1-one or “PPPBP”), 9,9-bis(4-hydroxyphenyl)fluorene, and bisphenol isophorone (also referred to as 4,4′-(3,3,5-trimethylcyclohexane-1,1-diyl)diphenol or “BPI”), 1,1-bis(4-hydroxy-3-methylphenyl)cyclohexane (“DMBPC”), tricyclopentadienyl bisphenol (also referred to as 4,4′-(octahydro-1H-4,7-methanoindene-5,5-diyl)diphenol), 2,2-bis(4-hydroxyphenyl)adamantane (“BCF”), 1,1-bis(4-hydroxyphenyl)-1-phenyl ethane (“BPAP”), and 3,3-bis(4-hydroxyphenyl)phthalide, or any combination thereof.

The polycarbonate may have a weight average molecular weight of 18,000 g/mol to 40,000 g/mol, 20,000 g/mol to 35,000 g/mol, or 21,000 g/mol to 30,000 g/mol. The polysiloxane-polycarbonate copolymer may have a weight average molecular weight of 18,000 g/mol, 19,000 g/mol, 20,000 g/mol, 21,000 g/mol, 22,000 g/mol, 23,000 g/mol, 24,000 g/mol, 25,000 g/mol, 26,000 g/mol, 27,000 g/mol, 28,000 g/mol, 29,000 g/mol, 30,000 g/mol, 31,000 g/mol, 32,000 g/mol, 33,000 g/mol, 34,000 g/mol, 35,000 g/mol, 36,000 g/mol, 37,000 g/mol, 38,000 g/mol, 39,000 g/mol, or 40,000 g/mol. The polycarbonate may have a weight average molecular weight of 21,800 g/mol. Weight average molecular weight can be determined by gel permeation chromatography (GPC) using BPA polycarbonate standards.
(ii) Polysiloxane-Polycarbonate Copolymers

The compositions may include one or more polysiloxane-polycarbonate copolymers. The polycarbonate structural unit of the polysiloxane-polycarbonate copolymer may be derived from the monomers of formula (2) as described above. The diorganosiloxane (referred to herein as “siloxane”) units can be random or present as blocks in the copolymer.

The polysiloxane blocks comprise repeating siloxane units of formula (3):

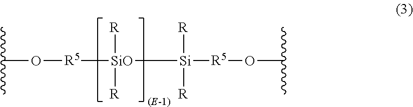

wherein each R is independently a C₁-C₁₃ monovalent organic group. For example, R can be a C₁-C₁₃ alkyl, C₁-C₁₃ alkoxy, C₂-C₁₃ alkenyl, C₂-C₁₃ alkenyloxy, C₃-C₆ cycloalkyl, C₃-C₆ cycloalkoxy, C₆-C₁₄ aryl, C₆-C₁₀ aryloxy, C₇-C₁₃ arylalkyl, C₇-C₁₃ aralkoxy, C₇-C₁₃ alkylaryl, or C₇-C₁₃ alkylaryloxy. The foregoing groups can be fully or partially halogenated with fluorine, chlorine, bromine, or iodine, or a combination thereof. Where a transparent poly(carbonate-siloxane) is desired, R is unsubstituted by halogen. Each R⁵ is independently a divalent C₁-C₃₀ organic group such as a C₁-C₃₀ alkyl, C₁-C₃₀ aryl, or C₁-C₃₀ alkylaryl. Generally. E has an average value of 2 to 1.000, specifically 2 to 500, 2 to 200, or 2 to 125, 5 to 80, or 10 to 70. E may have an average value of 10 to 80, 10 to 40, 40 to 80, or 40 to 70.

The polysiloxane blocks of formula (3) may be derived from the corresponding dihydroxy compound of formula (4):

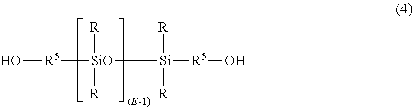

wherein R and E and R⁵ are as described for formula (4).

Specific pol siloxane blocks are of formula (5)

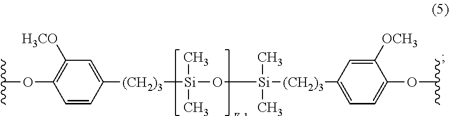

wherein E has an average value of 2 to 200, 2 to 125, 5 to 125, 5 to 100, 5 to 50, 20 to 80, or 5 to 20.

Polysiloxane blocks of formula (5) can be derived from the corresponding dihydroxy polysiloxane of formula (6):

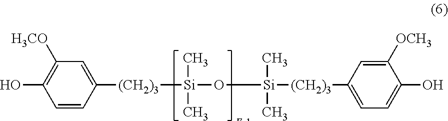

wherein E is as previously for formula (5).

Transparent polysiloxane-polycarbonate copolymers may comprise carbonate units of formula (1) derived from bisphenol A, and polysiloxane units as described above, in particular polysiloxane units of formula (6), wherein E has an average value of 4 to 50, or more specifically 40 to 50. The transparent copolymers can be manufactured using one or both of the tube reactor processes described in U.S. Patent Application No. 2004/0039145A1 or the process described in U.S. Pat. No. 6,723,864 can be used to synthesize the poly(siloxane-carbonate)s.

The polysiloxane-polycarbonate can comprise 50 to 99 weight percent of carbonate units and 1 to 50 weight percent siloxane units.

In an embodiment, a blend is used, in particular a blend of a bisphenol A homopolycarbonate and a polysiloxane-polycarbonate block copolymer of bisphenol A blocks and eugenol capped polydimethylsilioxane blocks, of the formula (7):

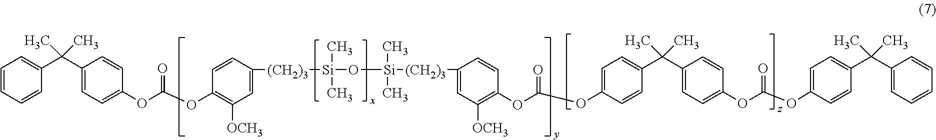

wherein x is 1 to 200, 5 to 85, 10 to 70, 15 to 65, or 40 to 60; y is 1 to 500, or 10 to 200, and z is 1 to 1000, or 10 to 800. In an embodiment, x is 1 to 200, y is 1 to 90 and z is 1 to 600, and in another embodiment, x is 30 to 50, y is 10 to 30 and z is 45 to 600. The polysiloxane blocks may be randomly distributed or controlled distributed among the polycarbonate blocks.

The polysiloxane-polycarbonate copolymer, such as a polydimethylsiloxane-polcarbonate copolymer, may include 1 wt % to 35 wt % siloxane content (e.g., polydimethylsiloxane content), 2 wt % to 30 wt % siloxane content, 5 wt % to 25 wt % siloxane content, 6 wt % to 20 wt % siloxane content, or 3 wt % to 9 wt % siloxane content. The polysiloxane-polycarbonate copolymer, such as a polydimethylsiloxane-polcarbonate copolymer, may include 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, or 35 wt % siloxane content. The polysiloxane-polycarbonate copolymer may include 6 wt % siloxane content. The polysiloxane-polycarbonate copolymer may include 20 wt % siloxane content. Siloxane content may refer to polydimethylsiloxane content.

The polysiloxane-polycarbonate copolymer may have a weight average molecular weight of 18,000 g/mol to 40,000 g/mol, 20,000 g/mol to 35,000 g/mol, or 22,000 g/mol to 32,000 g/mol. The polysiloxane-polycarbonate copolymer may have a weight average molecular weight of 17,000 g/mol, 18,000 g/mol, 19,000 g/mol, 20,000 g/mol, 21,000 g/mol, 22,000 g/mol, 23,000 g/mol, 24,000 g/mol, 25,000 g/mol, 26,000 g/mol, 27,000 g/mol, 28,000 g/mol, 29,000 g/mol, 30,000 g/mol, 31,000 g/mol, 32,000 g/mol, 33,000 g/mol, 34,000 g/mol, 35,000 g/mol, 36,000 g/mol, 37,000 g/mol, 38,000 g/mol, 39,000 g/mol, or 40,000 g/mol. The polysiloxane-polycarbonate copolymer may have a weight average molecular weight of 23.000 g/mol, or 30.000 g/mol.

The polysiloxane-polycarbonate copolymer may be present in the blend compositions in an amount ranging from 1 wt % to 99.8 wt % based on total weight of the composition.

In certain embodiments, the blend compositions include a polysiloxane-polycarbonate copolymer that is a para-cumyl phenol (PCP) end-capped BPA polycarbonate-polydimethylsiloxane copolymer comprising 6 wt % siloxane, having an average polydimethylsiloxane block length of 45 units, and having a weight average molecular weight of 23.000 g/mol [^{±}1.000 g/mol]; wherein the weight average molecular weight is as determined by gel permeation chromatography (GPC) using BPA polycarbonate standards.

(iii) Polyester-Polycarbonates

The compositions may include one or more polyester-polycarbonate copolymers. The polyester-polycarbonate may comprise repeating ester units of formula (8):

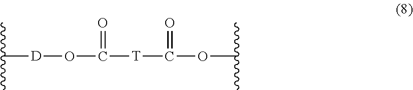

wherein D is a divalent group derived from a dihydroxy compound, and may be, for example, one or more alkyl containing C₆-C₂₀ aromatic group(s), or one or more C₆-C₂₀ aromatic group(s), a C₂-C₁₀ alkylene group, a C₆-C₂₀ alicyclic group, a C₆-C₂₀ aromatic group or a polyoxyalkylene group in which the alkylene groups contain 2 to 6 carbon atoms, specifically 2, 3, or 4 carbon atoms. D may be a C₂-C₃₀ alkylene group having a straight chain, branched chain, or cyclic (including polycyclic) structure. D may be derived from a compound of formula (2), as described above.

T of formula (8) may be a divalent group derived from a dicarboxylic acid, and may be, for example, a C₂-C₁₀ alkylene group, a C₆-C₂₀ alicyclic group, a C₆-C₂₀ alkyl aromatic group, a C₆-C₂₀ aromatic group, or a C₆-C₃ divalent organic group derived from a dihydroxy compound or chemical equivalent thereof. T may be an aliphatic group, and may be derived from a C₆-C₂₀ linear aliphatic alpha-omega (α-ω) dicarboxylic ester.

The C₆-C₂₀ linear aliphatic alpha-omega (α-ω) dicarboxylic acids may be adipic acid, sebacic acid, 3,3-dimethyl adipic acid, 3,3,6-trimethyl sebacic acid, 3,3,5,5-tetramethyl sebacic acid, azelaic acid, dodecanedioic acid, dimer acids, cyclohexane dicarboxylic acids, dimethyl cyclohexane dicarboxylic acid, norbornane dicarboxylic acids, adamantane dicarboxylic acids, cyclohexene dicarboxylic acids, or C₁₄, C₁₈ and C₂₀ diacids.

The ester units of the polyester-polycarbonates of formula (8) can be further described by formula (9), wherein T is (CH₂)ₘ, where m is 4 to 40, or optionally m is 4 to 18, m may be 8 to 10.

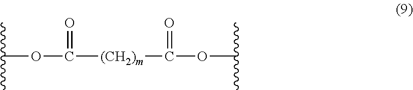

Saturated aliphatic alpha-omega dicarboxylic acids may be adipic acid, sebacic or dodecanedioic acid. Sebacic acid is a dicarboxylic acid having the following formula (10):

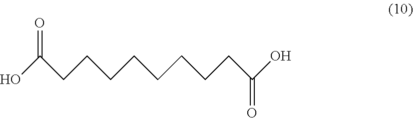 [SMILES: O=C(O)CCCCCCCCC(=O)O]

The poly(aliphatic ester)-polycarbonate can be a copolymer of aliphatic dicarboxylic acid units and carbonate units. The poly(aliphatic ester)-polycarbonate is shown in formula (11):

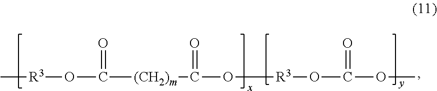

where each R³ is independently derived from a dihydroxyaromatic compound of formula (2), m is 4 to 18, and x and y each represent average weight percentages of the poly(aliphatic ester)-polycarbonate where x+y is 100.

A specific embodiment of the poly(aliphatic ester)-polycarbonate is shown in formula (12), where m is 4 to 18 and x and y are as defined for formula (11)

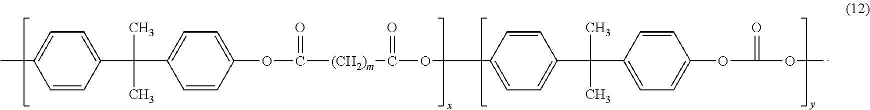

In a specific exemplary embodiment, a useful poly(aliphatic ester)-polycarbonate copolymer comprises sebacic acid ester units and bisphenol A carbonate units (formula (12), where m is 8).

The poly(aliphatic ester)-polycarbonate copolymer, may include 1 mole % to 25 mole % aliphatic dicarboxylic acid content, 0.5 mole % to 10 mole % aliphatic dicarboxylic acid content, 1 mole % to 9 mole % aliphatic dicarboxylic acid content, or 3 mole % to 8 mole % aliphatic dicarboxylic acid content. The polyester-polycarbonate copolymer, such as a poly(aliphatic ester)-polycarbonate copolymer, may include 1 mole %, 2 mole %, 3 mole %, 4 mole %, 5 mole %, 6 mole %, 7 mole %, 8 mole %, 9 mole %, 10 mole %, 11 mole %, 12 mole %, 13 mole %, 14 mole %, 15 mole %, 16 mole %, 17 mole %, 18 mole %, 19 mole %, 20 mole %, 21 mole %, 22 mole %, 23 mole %, 24 mole %, or 25 mole % aliphatic dicarboxylic acid content. The poly(aliphatic ester)-polycarbonate copolymer may have 8.25 mole % of sebacic acid. The poly(aliphatic ester)-polycarbonate copolymer may have 6.0 mole % of sebacic acid.

The polyester-polycarbonate copolymer may have a weight average molecular weight of 1,500 to 100,000 g/mol, 1,700 to 50,000 g/mol, 15,000 to 45,000 g/mol, 18,000 to 40,000 g/mol, 30,000 to 40,000 g/mol, 15,000 to 25,000 g/mol, 15,000 to 23,000 g/mol, or 20,000 to 25,000 g/mol. The polyester-polycarbonate copolymer, such as a poly(aliphatic ester)-polycarbonate copolymer may have a weight average molecular weight of 15,000 g/mol, 16,000 g/mol, 17,000 g/mol, 18,000 g/mol, 19,000 g/mol, 20,000 g/mol, 21,000 g/mol, 22,000 g/mol, 23,000 g/mol, 24,000 g/mol, 25,000 g/mol, 26,000 g/mol, 27,000 g/mol, 28,000 g/mol, 29,000 g/mol, 30,000 g/mol, 31,000 g/mol, 32,000 g/mol, 33,000 g/mol, 34,000 g/mol, 35,000 g/mol, 36,000 g/mol, 37,000 g/mol, 38,000 g/mol, 39,000 g/mol, or 40.000 g/mol. Molecular weight determinations are performed using gel permeation chromatography (GPC) using a cross linked styrene-divinyl benzene column, at a sample concentration of 1 milligram per milliliter, and as calibrated with BPA polycarbonate standards. Samples are eluted at a flow rate of 1.0 ml/min with methylene chloride as the eluent.

The polyester-polycarbonate copolymer, such as a poly(aliphatic ester)-polycarbonate copolymer, may be present in the blend compositions in an amount ranging from 1 wt % to 99.6 wt %, 4 wt % to 95 wt %, 1 wt % to 10 wt %, or 90 wt % to 99 wt %, based on total weight of the composition.

In certain embodiments, the blend compositions include a poly(aliphatic ester)-polycarbonate copolymer selected from the group consisting of: a PCP end-capped BPA polycarbonate-poly(aliphatic ester) copolymer comprising 6 mole % sebacic acid, and having a weight average molecular weight of 21,000 g/mol [^{±}1.000 g/mol]; and a PCP end-capped BPA polycarbonate-poly(aliphatic ester) copolymer comprising 6 mole % sebacic acid, and having a weight average molecular weight of 36,000 g/mol [^{±}1.000 g/mol]; or a combination thereof; wherein the weight average molecular weight is as determined by GPC using BPA polycarbonate standards.

(v) End Capping Agents

End capping agents can be incorporated into the polycarbonates. Exemplary chain-stoppers include certain monophenolic compounds (i.e., phenyl compounds having a single free hydroxy group), monocarboxylic acid chlorides, monocarboxylic acids, and/or monochloroformates. Phenolic chain-stoppers are exemplified by phenol and C₁-C₂₂ alkyl-substituted phenols such as p-cumyl-phenol, resorcinol monobenzoate, and p-tertiary-butylphenol, cresol, and monoethers of diphenols, such as p-methoxyphenol. Exemplary chain-stoppers also include cyanophenols, such as for example, 4-cyanophenol, 3-cyanophenol, 2-cyanophenol, and polycyanophenols. Alkyl-substituted phenols with branched chain alkyl substituents having 8 to 9 carbon atoms can be specifically be used.

(vii) Methods of Making Polycarbonates

The polycarbonates (e.g., homopolycarbonates, copolycarbonates, polycarbonate polysiloxane copolymers, polyester-polycarbonates) may be manufactured by processes such as interfacial polymerization, melt polymerization, and reactive extrusion. High Tg copolycarbonates are generally manufactured using interfacial polymerization.

Polycarbonates produced by interfacial polymerization may have an aryl hydroxy end-group content of 150 ppm or less, 100 ppm or less, or 50 ppm or less.

Reaction conditions for interfacial polymerization can vary. An exemplary process generally involves dissolving or dispersing one or more dihydric phenol reactants, such as bisphenol-A, in aqueous caustic soda or potash, adding the resulting mixture to a water-immiscible solvent medium (e.g., methylene chloride), and contacting the reactants with a carbonate precursor (e.g., phosgene) in the presence of a catalyst such as, for example, a tertiary amine (e.g., triethylamine) or a phase transfer catalyst, under controlled pH conditions. e.g., 8 to 11. The most commonly used water immiscible solvents include methylene chloride, 1,2-dichloroethane, chlorobenzene, toluene, and the like.

Exemplary carbonate precursors may include, for example, a carbonyl halide such as carbonyl dibromide or carbonyl dichloride (also known as phosgene), or a haloformate such as a bishaloformate of a dihydric phenol (e.g., the bischloroformate of bisphenol-A, hydroquinone, or the like) or a glycol (e.g., the bishaloformate of ethylene glycol, neopentyl glycol, polyethylene glycol, or the like). Combinations comprising at least one of the foregoing types of carbonate precursors can also be used. In certain embodiments, the carbonate precursor is phosgene, a triphosgene, diacyl halide, dihaloformate, dicyanate, diester, diepoxy, diarylcarbonate, dianhydride, dicarboxylic acid, diacid chloride, or any combination thereof. An interfacial polymerization reaction to form carbonate linkages may use phosgene as a carbonate precursor, and is referred to as a phosgenation reaction.

Among tertiary amines that can be used are aliphatic tertiary amines such as triethylamine, tributylamine, cycloaliphatic amines such as N,N-diethyl-cyclohexylamine and aromatic tertiary amines such as N,N-dimethylaniline.

Exemplary phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁-C₈ alkoxy group or a C₆-C₁₈ aryloxy group. An effective amount of a phase transfer catalyst can be 0.1 to 10 wt % based on the weight of bisphenol in the phosgenation mixture.

In one embodiment, the polycarbonate encompassed by this disclosure is made by an interfacial polymerization process.

In another embodiment, the polycarbonate encompassed by this disclosure excludes the utilization of a melt polymerization process to make at least one of said polycarbonates.

Protocols may be adjusted so as to obtain a desired product within the scope of the disclosure and this can be done without undue experimentation. A desired product is in one embodiment to achieve a molded article of the composition comprising a polycarbonate having a transmission level higher than 90.0%, as measured by ASTM D1003-00, at 2.5 mm thickness and a YI lower than 1.5, as measured by ASTM D1925-70(1988), with an increase in YI lower than 2 during 2000 hours of heat aging at 130° C., made by an interfacial process.

The enhanced optical properties can be achieved by employing in the interfacial process a starting BPA monomer having both an organic purity (e.g., measured by HPLC of greater than or equal to 99.65 wt %) and a sulfur level of less than or equal to 2 ppm. The organic purity can be defined as 100 wt % minus the sum of known and unknown impurities detected using ultraviolet (UV) (see HPLC method in Nowakowska et al., Polish J. Appl. Chem., XI(3), 247-254 (1996)). The use of an end-capping agent can be employed in the reaction such that the resultant composition comprising BPA polycarbonate comprises a free hydroxyl level less than or equal to 150 ppm. Also, the sulfur level in the resultant composition can be less than or equal to 2 ppm, as measured by a commercially available Total Sulfur Analysis based on combustion and coulometric detection.

Poly(aliphatic ester)-polycarbonates may be prepared by interfacial polymerization. Rather than utilizing the dicarboxylic acid (such as the alpha, omega C₆₋₂₀ aliphatic dicarboxylic acid) per se, it is possible, and sometimes even preferred, to employ the reactive derivatives of the dicarboxylic acid, such as the corresponding dicarboxylic acid halides, and in particular the acid dichlorides and the acid dibromides. Thus, for example, it is possible, and even desirable, to use acid chloride derivatives such as a C₆ dicarboxylic acid chloride (adipoyl chloride), a Cl₁₀ dicarboxylic acid chloride (sebacoyl chloride), or a C₁₂ dicarboxylic acid chloride (dodecanedioyl chloride). The dicarboxylic acid or reactive derivative may be condensed with the dihydroxyaromatic compound in a first condensation, followed by in situ phosgenation to generate the carbonate linkages with the dihydroxyaromatic compound. Alternatively, the dicarboxylic acid or derivative may be condensed with the dihydroxyaromatic compound simultaneously with phosgenation.

The polymers may be manufactured using a reactive extrusion process. For example, a poly(aliphatic ester)-polycarbonate may be modified to provide a reaction product with a higher flow by treatment using a redistribution catalyst under conditions of reactive extrusion. For example, a poly(aliphatic ester)-polycarbonate with an MVR of less than 13 cc/10 min when measured at 250° C., under a load of 1.2 kg, may be modified to provide a reaction product with a higher flow (e.g., greater than or equal to 13 cc/10 min when measured at 250° C., under a load of 1.2 kg), by treatment using a redistribution catalyst under conditions of reactive extrusion. During reactive extrusion, the redistribution catalyst may be injected into the extruder being fed with the poly(aliphatic ester)-polycarbonate, and optionally one or more additional components.

Particularly useful redistribution catalysts include a tetra C₁₋₆ alkylphosphonium hydroxide, a C₁₋₆ alkyl phosphonium phenoxide, or a combination comprising one or more of the foregoing catalysts. An exemplary redistribution catalyst is tetra-n-butylphosphonium hydroxide.

The polycarbonates may be prepared by a melt polymerization process.

B. Photochromic Dye

The compositions include at least one photochromic dye. A photochromic material is one that changes its color when it is exposed to light, and reverts back to its original color when the light is absent. Photochromic dyes are light-responsive molecules that may be spiropyran or spiro-oxazine based compounds. Upon irradiation (ultra-violet light, visible light or both), the photochromic dyes undergo reversible intramolecular rotation that leads to the rearrangement of conjugated systems resulting in color changes. The photochromic dyes described herein require about 90° rotation of one half of the molecule when rearranging between the clear and the colored state of the molecule. To effect a color change, the polymer matrix has to offer enough free volume for the intramolecular rearrangement to occur. Therefore, the polymer matrix parameters such as molecular transitions, T_{g}, free volume, and chain stiffness affect the ability of the dye to be effective in imparting photochromic properties to the composition.

The photochromic dye may belong to the general class of compounds known as the naphthoxazines. More specifically, the photochromic dye may belong to a class of compounds known as 2,1-b naphthoxazines and have a 2,1-b napthoxazine core structure.

The naphthoxazine dye may be particularly useful as a photochromic dye because of its high resistance to fatigue, high photostability and good photosensitivity.

The photochromic dye may belong to the general class of compounds known as the naphthopyrans. More specifically, the photochromic dye may belong to a class of compounds known as 1,2-b naphthopyrans and have a 1,2-b naphthopyran core structure.

The compositions may comprise, by weight, up to 1.0 wt % of the photochromic dye. The compositions may comprise, by weight, 0.01%, 0.02%, 0.03%, 0.04%, 0.05%, 0.06%, 0.07%, 0.08%, 0.09%, 0.10%, 0.11%, 0.12%, 0.13%, 0.14%, 0.15%, 0.16%, 0.17%, 0.18%, 0.19%, 0.20%, 0.25%, 0.30%, 0.35%, 0.40%, 0.45%, 0.50%, 0.55%, 0.60%, 0.65%, 0.70%, 0.75%, 0.80%, 0.85%, 0.90%, or 1.0% of the photochromic dye.

C. Additional Components

The compositions may comprise additional components, such as one or more additives. Suitable additives include, but are not limited to impact modifiers, UV stabilizers, colorants, flame retardants, heat stabilizers, plasticizers, lubricants, mold release agents, fillers, reinforcing agents, antioxidant agents, antistatic agents, blowing agents, anti-drip agents, and radiation stabilizers.

Exemplary additives for inclusion in the blend compositions include, for example, pentaerythritol tetrastearate (PETS), phosphite stabilizer (e.g., Iragafos 168), Joncryl ADS (styrene-acrylate-epoxy oligomer), and any combination thereof.

### 3. Properties of the Compositions

The blend compositions may have a combination of desired properties. The compositions may have improved optical properties, color fading properties, thermal stability, or a combination thereof.

The blend compositions may be particularly suitable for use in the manufacture of articles. An article may be molded from the blend composition. The molded article may have a combination of desired properties. For example, the article may have desirable color fading properties, improved optical properties, improved thermal stability of the photochromic dye, or a combination thereof.

A. Color Fading

To study and compare the fading rate of the blend compositions in terms of total color shift (dE), regression equations linking the absorbance at λₘₐₓ and dE may be calculated and used. Regression equations may be obtained by measuring the CIELab L*, a* and b* values and the absorbance at λₘₐₓ measured at regular time intervals up to 600 seconds. Color measurements may be carried out using a Gretag Macbeth ColorEye 7000A between 360 and 750 nm, whereas the absorbance date may be collected using a Perkin Elmer Lamba 800 spectrophotometer. The regression equations may be generated from the linear plot of absorbance at λₘₐₓ vs. dE.

The total color fading behavior of a photochromic dye may be evaluated in a polycarbonate blend based on the average total decoloration rate (∂(dE)), or color shift rate, over a certain time range calculated according to the equation 1,

$$\partial ( dE ) = \frac{Δ ( {dE}_{t = 0} - {dE}_{t} )}{Δ ( {t}_{0} - t )} \qquad eq . 1$$

where dE=ₜ₌₀ is the time at which the UV radiation is turned off (after irradiating for 300 seconds), and is regarded as the maximum excited state of the dye, dEₜ is the dE value at the desired time, t₀ is zero, and t is the desired time. UV irradiation may be achieved by a UV lamp emitting UV light at a wavelength between 100 nm and 400 nm. In an embodiment, UV irradiation may be achieved by a UV lamp emitting light at a wavelength between 315 nm and 400 nm with emission peaks at 352 and 368 nm.

The total color shift rate of a molded article, ∂(dE), may be at least 0.1 min⁻¹, at least 0.2 min⁻¹, at least 0.3 min⁻¹, at least 0.4 min⁻¹, at least 0.5 min⁻¹, at least 0.6 min⁻, at least 0.7 min⁻¹, at least 0.8 min⁻¹, at least 0.9 min⁻¹, at least 1.0 min⁻¹, at least 1.1 min⁻¹ at least 1.2 min⁻¹, at least 1.3 min⁻¹, at least 1.4 min⁻¹, at least 1.5 min⁻¹, at least 1.6 min⁻¹, at least 1.7 min⁻¹, at least 1.8 min⁻¹, at least 1.9 min⁻¹, at least 2.0 min⁻¹, at least 2.1 min⁻¹, at least 2.2 min⁻¹, at least 2.3 min⁻¹, at least 2.4 min⁻¹, at least 2.5 min⁻¹, at least 2.6 min⁻¹, at least 2.7 min⁻¹, at least 2.8 min⁻¹, at least 2.9 min⁻¹, or at least 3.0 min⁻¹, at fifteen seconds after the article is subjected to 300 seconds of UV irradiation. UV irradiation may be achieved by a UV lamp emitting UV light at a wavelength between 100 nm and 400 nm. In an embodiment, UV irradiation may be achieved by a UV lamp emitting light at a wavelength between 315 nm and 400 nm with emission peaks at 352 and 368 nm.

The fade behavior of spirooxazine and naphtopyran photochromic dyes in polymer matrices is characterized by exponential decay and consists of a fast and a slow component. The fast component is associated with the fast fade kinetics that occur over the first few minutes of decoloration, whereas the slow component is related to the slow fade kinetics at the tail of the exponential curves. The decoloration of photochromic dyes may be analyzed by the standard biexponential equation (eq. 2) that allows good comparison between decoloration kinetics in different polymer matrices.

A(t)=A₁e^{-k}^{₁}^{t}+A₂e^{-k}^{₂}^{t}+Aₜₕ eq. 2

A(t) is the optical density at λₘₐₓ of the colored form; A₁ and A₂ are contributions to the initial absorption; A₀, k₁ and k₂ are the rates of the fast and slow components; and Aₜₕ is the residual coloration (offset).

The initial discoloration rate of a molded article, k₁, may be at least 0.1 min⁻¹, at least 0.15 min⁻¹, at least 0.2 min⁻¹, at least 0.25 min⁻¹, at least 0.3 min⁻¹, at least 0.35 min⁻¹, at least 0.4 min⁻¹, at least 0.45 min⁻¹, at least 0.5 min⁻¹, at least 0.55 min⁻¹, at least 0.6 min⁻¹, at least 0.65 min⁻¹, at least 0.7 min⁻¹, at least 0.75 min⁻¹, at least 0.8 min⁻¹, at least 0.85 min⁻¹, at least 0.9 min⁻¹, at least 0.95 min⁻¹, or at least 1.0 min^{t}, at fifteen seconds after the article is subjected to 300 seconds of UV irradiation. UV irradiation may be achieved by a UV lamp emitting UV light at a wavelength between 100 nm and 400 nm. In an embodiment. UV irradiation may be achieved by a UV lamp emitting light at a wavelength between 315 nm and 400 nm with emission peaks at 352 and 368 nm.

B. Thermal Stability of the Photochromic Dye

Gradient HPLC may be used to establish the degradation level of the photochromic dye in the blended composition as function of molding (barrel) temperature. Concentration of the photochromic dye in a sample can be determined in comparison to a standard curve. The obtained concentration may be compared to the starting concentration of the dye in the initial blend formulation to determine the percent degradation of the photochromic dye.

The degradation of the photochromic dye in the article may be less than 30%, less than 29%, less than 28%, less than 27%, less than 26%, less than 25%, less than 24%, less than 23%, less than 22%, less than 21%, less than 20%, less than 19%, less than 18%, less than 17%, less than 17%, less than 15%, less than 14%, less than 13%, less than 12%, less than 11%, less than 10%, less than 9%, less than 8%, less than 7%, less than 6%, less than 5%, less than 4%, less than 3%, less than 2%, or less than 1%, after molding the article at 270° C.

The degradation of the photochromic dye in the article may be less than 30% after molding the article at 300° C., 295° C., 290° C., 285° C. 280° C. 275° C., 270° C., 265° C., 260° C., 255° C., or 250° C. The degradation of the photochromic dye in the article may be less than 25% after molding the article at 300° C. 295° C. 290° C., 285° C., 280° C., 275° C., 270° C. 265° C. 260° C., 255° C. or 250° C. The degradation of the photochromic dye in the article may be less than 20% after molding the article at 300° C. 295° C., 290° C., 285° C., 280° C., 275° C., 270° C. 265° C., 260° C., 255° C., or 250° C. The degradation of the photochromic dye in the article may be less than 15% after molding the article at 300° C., 295° C., 290° C. 285° C., 280° C., 275° C., 270° C. 265° C. 260° C., 255° C., or 250° C. The degradation of the photochromic dye in the article may be less than 10% after molding the article at 300° C. 295° C. 290° C., 285° C., 280° C., 275° C., 270° C. 265° C. 260° C., 255° C., or 250° C.

### 4. Methods of Preparing the Blend Compositions

The compositions disclosed herein can be manufactured by various methods. For example, a composition may be first mixed in a high speed HENSCHEL-Mixer®. Other low shear processes, including but not limited to hand mixing, can also accomplish this blending. The mixed composition may then be fed into the throat of a single or twin-screw extruder via a hopper. Alternatively, at least one of the components can be incorporated into the composition by feeding directly into the extruder at the throat and/or downstream through a side-feeder. Additives can also be compounded into a master-batch with a desired polymeric resin and fed into the extruder. The extruder may be generally operated at a temperature higher than that necessary to cause the composition to flow. The extrudate may be immediately quenched in a water batch and pelletized. The pellets, so prepared, when cutting the extrudate can be one-fourth inch long or less as desired. Such pellets can be used for subsequent molding, shaping, or forming.

The polycarbonate blend composition may be extruded at 250° C. to 300° C. The polycarbonate blend composition may be extruded at 250° C., 255° C., 260° C., 265° C., 270° C., 275° C., 280° C., 285° C., 290° C., 295° C. or 300° C.

In certain embodiments, the compositions may undergo a reactive extrusion process, as described herein, by injection of a redistribution catalyst into the extruder during the extrusion process.

### 5. Articles

Shaped, formed, or molded articles comprising the polycarbonate compositions are also provided. Exemplary articles include, but are not limited to, photochromic lens, sunglass lens, eyeglass lens, transition lens, window, glazing, auto glazing, sheet film, and roofing.

The article may have a thickness of 1 mm to 6 mm, 1 mm to 2 mm, 1 mm to 3 mm, 1 mm to 4 mm, 1 mm to 5 mm, 2 mm to 6 mm, 3 mm to 6 mm, 4 mm to 6 mm, 5 mm to 6 mm, 2 mm to 3 mm, 2 mm to 4 mm, 2 mm to 5 mm, 2 mm to 6 mm, 3 mm to 4 mm, 3 mm to 5 mm, or 4 mm to 5 mm.

### 6. Methods of Preparing the Articles

Standard processing conditions used to manufacture transparent thermoplastic articles, such as those containing (co)polycarbonate and poly(methyl methacrylate), cannot be applied to compounding in photochromic dyes due to the high temperatures required for processing of these compositions. High temperatures are required in these processes due to the relatively high T_{g} of these materials, and the high processing temperatures result in degradation of the photochromic dye.

Accordingly, a process of compounding photochromic dyes into the thermoplastic formulation of this disclosure was designed and employed to produce molded articles with intrinsic photochromic properties via direct extrusion and injection molding or extruded sheet/film applications. These process conditions allow photochromic dyes to be incorporated into polycarbonates with limited decomposition of the dyes. These conditions also offer a broad application window to manufacture photochromic articles directly via extrusion and/or (injection) molding. As such, this process overcomes previously disclosed methods for making similar articles, which rely upon labor intensive methods and costly photochromic coatings.

The polycarbonate blend compositions may be molded into useful shaped articles by injection molding, extrusion, and/or sheet or film extrusion, or a combination thereof. The extruded polycarbonate blend, as prepared and described above, may be molded via injection molding at 300° C. or less, 295° C. or less, 290° C. or less, 285° C. or less, 280° C. or less, 275° C. or less, 270° C. or less, 265° C. or less, 260° C. or less, 255° C. or less, or 250° C. or less, to form the article. The extruded polycarbonate blend, as prepared and described above, may be extruded into a sheet or film at 300° C. or less, 295° C. or less, 290° C. or less, 285° C. or less, 280° C. or less, 275° C. or less, 270° C. or less, 265° C. or less, 260° C. or less, 255° C. or less, or 250° C. or less, to form the sheet or film.

A wide variety of articles can be manufactured using the disclosed compositions, including photochromic lenses, sunglass lenses, eyeglass lenses, transition lenses, windows, glazing, auto glazing, sheets, films, sheet films, roofing, and the like. Further description of the methods used for manufacture of the articles disclosed herein may be found in the following non-limiting examples.

### 7. Examples

Molecular weight determinations were performed using gel permeation chromatography (GPC), using a cross-linked styrene-divinylbenzene column and calibrated to bisphenol-A polycarbonate standards using a UV-VIS detector set at 254 nm. Samples were prepared at a concentration of 1 mg/ml, and eluted at a flow rate of 1.0 ml/min.

Yellowness index (YI) is measured in accordance with ASTM D1925-70(1988), while transmission is measured in accordance with ASTM D-1003-00. Procedure A, using a HAZE-GUARD DUAL from BYK-Gardner, using and integrating sphere (0°/diffuse geometry), wherein the spectral sensitivity conforms to the International Commission on Illumination (CIE) standard spectral value under standard lamp D65.

Table 1 summarizes the exemplary materials components of the polycarbonate blend compositions. The listed copolymers and polycarbonate resins were prepared by methods known in the art. All other chemical entities were purchased from the commercial sources listed.

TABLE 1

| | | |
|---|---|---|
| PC-1 | Linear Bisphenol A Polycarbonate, produced | SABIC-IP |
| | via interfacial polymerization, Mw 21,800 | |
| | g/mol as determined by GPC using poly- | |
| | carbonate standards, phenol end-capped, | |
| | PDI = 2-3 | |
| PC-2 | DMBPC - Bisphenol A Polycarbonate copol- | SABIC-IP |
| | ymer containing 50 mol % DMBPC (1,1- | |
| | bis(4-hydroxy-3-methylphenyl)cyclohexane), | |
| | Mw 23,300 g/mol as determined by GPC | |
| | using polycarbonate standards | |
| PC-Si-1 | PDMS (polydimethylsiloxane) - Bisphenol | SABIC-IP |
| | A Polycarbonate copolymer, produced via | |
| | interfacial polymerization, 6 wt % | |
| | siloxane, average PDMS block length of | |
| | 45 units (D45), Mw 23,000 g/mol as | |
| | determined by GPC using polycarbonate | |
| | standards, para-cumylphenol (PCP) end- | |
| | capped, PDI = 2-3 | |
| PE-PC-1 | Poly(aliphatic ester) - Bisphenol A poly- | SABIC-IP |
| | carbonate copolymer, 6 mole % sebacic | |
| | acid, Mw 21,000 g/mol as determined by | |
| | GPC using polycarbonate standards, para- | |
| | cumylphenol (PCP) end-capped. | |
| PE-PC-2 | Poly(aliphatic ester) - Bisphenol A poly- | SABIC-IP |
| | carbonate copolymer, 6 mole % sebacic | |
| | acid, Mw 36,000 g/mol as determined by | |
| | GPC using polycarbonate standards, para- | |
| | cumylphenol (PCP) end-capped. | |
| PETS | Pentaerythritol Tetrastearate | LONZA |
| PD-1 | 2,1-b napthoxazine dye - Reversacol ® | VIVIMED |
| | Palatinate Purple | |
| PD-2 | 1,2-b naphthopyran dye - Reversacol ® | VIVIMED |
| | Amber | |
| Phosphite | Tris(di-t-butylphenyl)phosphite | BASF |
| stabilizer | | |
| Joncryl ADR | Styrene-acrylate-epoxy oligomer | BASF |
| 4368CS | | |

### Example 1. Polycarbonate Compositions Comprising Photochromic Dyes

Four polycarbonate matrices were used to investigate the color fading performance of two photochromic dyes. Standard polycarbonate was used as a baseline composition (7 and 8). The remaining three polycarbonate matrices employed were used to prepare copolymer-based compositions (1-6). Blends of exemplary compositions were prepared according to the components and their weight percentages shown in Table 2.

TABLE 2

| | Composition | | | | | | | |
|---|---|---|---|---|---|---|---|---|
| | 1 | 2 | 3 | 4 | 5 | 6 | 7 | 8 |
| PC-1 (%) | — | — | — | — | — | — | 99.62 | 99.62 |
| PC-2 (%) | — | — | — | — | 99.45 | 99.45 | — | — |
| PC-Si-1 (%) | — | — | 99.62 | 99.62 | — | — | — | — |
| PE-PC-1 (%) | 95.02 | 95.02 | — | — | — | — | — | — |
| PE-PC-2 (%) | 4.5 | 4.5 | — | — | — | — | — | — |
| PD-1 (%) | 0.05 | — | 0.05 | — | 0.05 | — | 0.05 | — |
| PD-2 (%) | — | 0.05 | — | 0.05 | — | 0.05 | — | 0.05 |
| Tris(di-t- | 0.06 | 0.06 | 0.06 | 0.06 | 0.1 | 0.1 | 0.06 | 0.06 |
| butylphenyl)phosphite (%) | | | | | | | | |
| PETS (>90% esterified) (%) | 0.27 | 0.27 | 0.27 | 0.27 | 0.4 | 0.4 | 0.27 | 0.27 |
| Joncryl ADR 4368CS | 0.1 | 0.1 | — | — | — | — | — | — |
| (milled version of 722224) (%) | | | | | | | | |

Exemplary formulations were prepared by direct blending of all the ingredients, including the photochromic dyes, followed by mechanical homogenization by means of a paint shaker. The blends were pelletized by means of a twin-screw extruder at 240° C.

Molded plaques having 1.6 mm thickness were obtained via injection molding at 240° C. (mold temperature). A typical injection molding profile is summarized in Table 3. Additional parameters are as follows, injection time: 1.77 s, cycle time: 35 s, buffer 9.9 mm, residence time: 157 s.

TABLE 3

| | |
|---|---|
| Injection | Temperature |

| | | | | |
|---|---|---|---|---|
| Injection speed | 25 | mm/s | T hopper | 40° C. |
| Injection pressure | 145 | bar | T zone 1 | 220° C. |
| Switch over point | 10 | mm | T zone 2 | 230° C. |
| After pressure | 40 | bar | T zone 3 | 240° C. |
| After pressure time | 10 | s | T nozzle | 235° C. |
| Cooling time | 20 | s | T mold | 80° C. |
| Screw diameter | 22 | mm | | |

The photochromic response of molded plaques was studied by exposing the plaques to a UV lamp emitting UV light between 315 nm and 400 nm with emission peaks at 352 and 368 nm. The decoloration of the plaques was studied by irradiating the molded plaques with UV light for 300 seconds. Irradiation took place at a distance of ca. 20 cm parallel from the UV lamp. Molded plaques were kept in the dark for at least 24 hours prior UV exposure. The coloration of the plaques was monitored in time by recording the absorbance at λₘₐₓ every 0.5 sec for a period of 30 minutes using a Perkin Elmer Lamba 800 spectrophotometer. The λₘₐₓ absorbance used was 600 nm for PD-1 and 570 nm for PD-2. Experimental data were baseline corrected by subtracting the absorbance at λₘₐₓ before irradiation.

### Example 2. Correlation Between Total Color Shift (dE) and Absorbance

To study and compare the fading rate in terms of total color shift (dE), regression equations linking the absorbance at λₘₐₓ and dE were calculated. Color measurements (CIELab L*, a* and b* values) and the absorbance at λₘₐₓ were measured for composition 3. These values are reported in Table 4.

TABLE 4

| Time | | | | | | Corrected |
|---|---|---|---|---|---|---|
| (sec) | L | a | B | dE* | λₘₐₓ | λₘₐₓ** |
| 0 | 84.028 | −9.455 | 4.940 | 5.516 | 0.2735 | 0.0730 |
| 20 | 84.46 | −9.295 | 5.524 | 4.772 | 0.2633 | 0.0628 |
| 40 | 84.714 | −9.201 | 5.871 | 4.332 | 0.2571 | 0.0566 |
| 60 | 84.908 | −9.13 | 6.144 | 3.989 | 0.2527 | 0.0522 |
| 120 | 85.33 | −8.964 | 6.731 | 3.248 | 0.2428 | 0.0422 |
| 180 | 85.585 | −8.875 | 7.087 | 2.801 | 0.2369 | 0.0364 |
| 240 | 85.765 | −8.802 | 7.325 | 2.494 | 0.2327 | 0.0322 |
| 300 | 85.887 | −8.753 | 7.495 | 2.279 | 0.2298 | 0.0293 |
| 360 | 85.99 | −8.717 | 7.629 | 2.107 | 0.2276 | 0.0270 |
| 420 | 86.069 | −8.682 | 7.742 | 1.964 | 0.2257 | 0.0251 |
| 480 | 86.134 | −8.652 | 7.824 | 1.856 | 0.2242 | 0.0237 |
| 540 | 86.187 | −8.635 | 7.896 | 1.765 | 0.2230 | 0.0225 |
| 600 | 86.232 | −8.608 | 7.954 | 1.688 | 0.2219 | 0.0213 |

*dE was calculated as the difference in color (L, a, b) before and after UV irradiation
**The λₘₐₓ was baseline corrected by subtracting the absorbance at λₘₐₓ before UV irradiation

Scatter plots could be generated from the linear plot of absorbance at λₘₐₓ vs. dE. Calculated regression equations for all the compositions are reported in Table 5. In the table y=dE and x=absorbance at λₘₐₓ.

TABLE 5

| Composition | Regression equation |
|---|---|
| 1 | y = 74.241x + 0.0800 |
| 2 | y = 96.173x + 0.0508 |
| 3 | y = 74.476x + 0.0969 |
| 4 | y = 96.917x + 0.0348 |
| 5 | y = 81.580x + 0.0428 |
| 6 | y = 96.963x + 0.0500 |
| 7 | y = 72.548x + 0.0763 |
| 8 | y = 96.963x + 0.0708 |

### Example 3. Fading Behavior of PD-1

The total color fading behavior of PD-1 was evaluated in all four (co)polycarbonate matrices. The results are summarized in Table 6. dE indicates the total color difference calculated using the L*a*b* color coordinates; ∂(dE) is the average total color shift rate obtained using eq. 1; Δ % quantifies the percent difference in color change compared to the standard polycarbonate (7).

TABLE 6

| | Composition | | | | | | | | | | |
|---|---|---|---|---|---|---|---|---|---|---|---|
| | 7 | | 1 | | | 3 | | | 5 | | |
| Time (sec) | dE | ∂ (dE) | dE | ∂ (dE) | Δ % | dE | ∂ (dE) | Δ % | dE | ∂ (dE) | Δ % |
| 0 | 5.46 | | 5.20 | | | 5.26 | | | 2.31 | | |
| 15 | 5.03 | 1.99 | 4.65 | 2.46 | 23.64 | 4.65 | 2.83 | 42.28 | 2.16 | 0.45 | −77.40 |
| 30 | 4.70 | 1.86 | 4.30 | 2.27 | 22.13 | 4.27 | 2.45 | 32.12 | 2.04 | 0.50 | −73.08 |
| 45 | 4.46 | 1.56 | 4.11 | 1.87 | 20.08 | 4.07 | 2.03 | 29.93 | 1.99 | 0.46 | −70.62 |
| 60 | 4.28 | 1.18 | 3.97 | 1.23 | 3.90 | 3.83 | 1.42 | 20.26 | 1.85 | 0.46 | −61.00 |
| 120 | 3.69 | 0.89 | 3.37 | 0.92 | 3.36 | 3.27 | 0.99 | 11.97 | 1.57 | 0.37 | −58.28 |
| 300 | 2.84 | 0.52 | 2.58 | 0.52 | −0.15 | 2.49 | 0.55 | 5.45 | 1.15 | 0.23 | −55.79 |
| 600 | 2.22 | 0.32 | 1.98 | 0.32 | −0.67 | 1.91 | 0.33 | 3.16 | 0.93 | 0.14 | −57.35 |
| 900 | 1.88 | 0.24 | 1.68 | 0.23 | −1.56 | 1.66 | 0.24 | 0.59 | 0.70 | 0.11 | −55.08 |
| 1800 | 1.39 | 0.14 | 1.22 | 0.13 | −2.36 | 1.30 | 0.13 | −2.98 | 0.49 | 0.06 | −55.40 |

Although the resulting total color shift, dE, of the molded plaques after 300 sec of UV irradiation was comparable between compositions 7, 1, and 3, the decoloration behavior varied significantly. The average decoloration rate was time and (co)polycarbonate composition related, especially within the first 60-120 seconds. The only exception was composition 5, in which both coloration and decoloration were significantly slower in comparison.

After only 15 seconds in the dark, compositions 1 and 3 showed improved total color decay when compared to composition 7 (23% and 43%). Allowing the molded plaques to decay up to the total extent of the experiment (1800 seconds) revealed that the difference between compositions 7, 1, and 3 gradually level off at 900 seconds.

The percent of color change variation, compared to composition 7, is also shown in Table 6. Both compositions 1 and 3 showed improved color fading behavior that exponentially decayed over time.

Based on the biexponential model described above, the data shown in Table 6 revealed that the matrix composition influenced the kinetics of decoloration behavior of PD-1. Specifically, compositions 1 and 3 enhanced the fast component of the fade kinetics, whereas composition 5 slowed the fading kinetics compared to standard polycarbonate (composition 7). Table 7 details the kinetics factors calculated by fitting absorbance obtained at λₘₐₓ (600 nm) against eq. 2.

TABLE 7

| Composition | 1 | 3 | 5 | 7 |
|---|---|---|---|---|
| A₀ | 0.013 | 0.015 | 0.006 | 0.017 |
| A₁ | 0.022 | 0.024 | 0.014 | 0.024 |
| k₁ | 0.653 | 0.788 | 0.085 | 0.220 |
| A₂ | 0.030 | 0.027 | 0.009 | 0.031 |
| k₂ | 0.087 | 0.095 | 0.602 | 0.087 |

Data reported in Table 7 highlight the effect that the type of copolymer matrix imposed on the initial decoloration rate (k₁) of the dye. In fact, k₁ significantly increased (faster initial decoloration), up to ca. 240%, in the presence of low T_{g} soft blocks within the co-polymer structure compared to standard polycarbonate. These trends are consistent with the total average decoloration (∂(dE)).

These results demonstrate that the presence of soft/flexible blocks within the polycarbonate of compositions 1 and 3 results in improvement of the decoloration of molded plaques, especially within the first 60-120 seconds. This may be due to the increased chain flexibility and free volume in comparison to standard polycarbonate (composition 7). Under these conditions and within this matrix, the photochromic dye can rearrange efficiently to effect coloration and decoloration. In addition, the type of soft block has proven to have different effects on the decoloration kinetics of PD-1. In particular, the PDMS blocks of composition 3 act as better soft block than the aliphatic blocks of sebacic acid of composition 1. On the contrary, the addition of bulky/rigid co-monomer (composition 5) within the (co)polycarbonate caused a significant negative effect on both coloration and decoloration behavior of PD-1.

### Example 3. Fading Behavior of PD-2

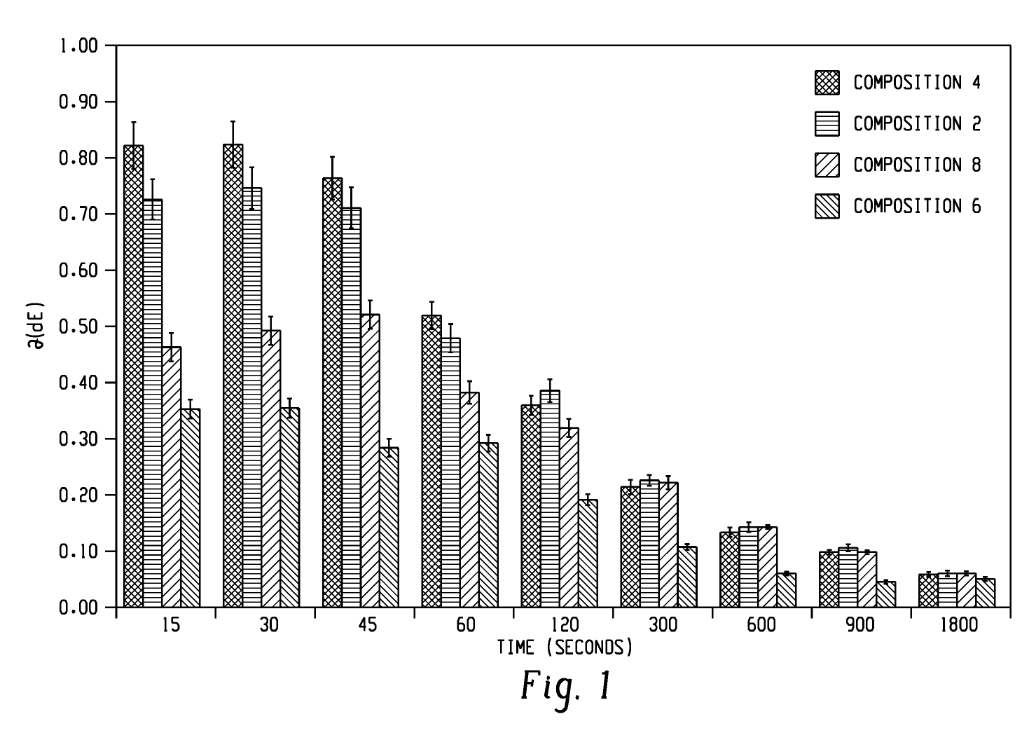

In similar fashion to PD-1, the fading kinetics of PD-2 were investigated in the four (co)polycarbonate matrices by comparing the average total decoloration rate (∂(dE)) defined by eq. 1. FIG. 1 illustrates the ∂(dE) difference between the initial value after 300 sec of UV irradiation and that measured after a pre-determined time interval (Δ) for compositions 2, 4, 6, and 8.

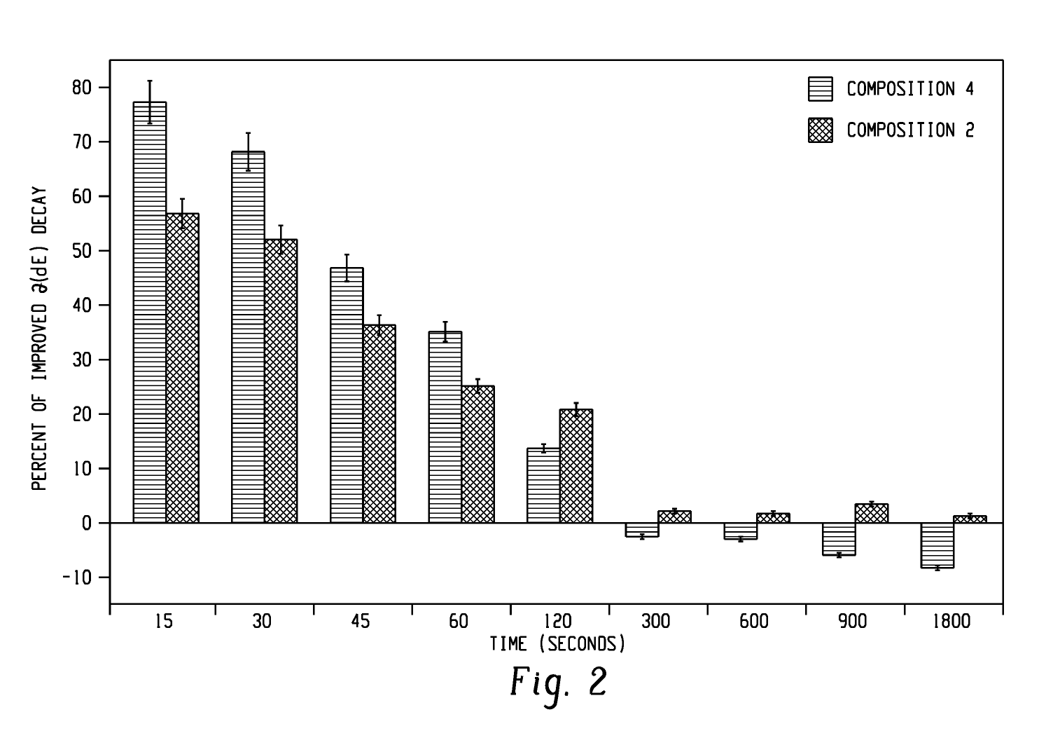

Although PD-2 has a lighter total coloration compared to PD-1, the effect of the (co)polycarbonate matrix was apparent and followed a decay-type behavior as a function of time. FIG. 2 illustrates a graphical representation of the percent of total color fading of compositions 2 and 4 when compared to composition 8. In comparison to PD-1, the percent improved ∂(dE) was even more pronounced and reached 75% over the first 15 seconds of color decay for composition 4. Therefore, the introduction of low T_{g} blocks within the copolymer chains was amplified in a naphthopyran dye such as PD-2.

### Example 4. Influence of Molding Conditions on the Thermal Stability of PD-1

Gradient HPLC was used to establish the degradation level of PD-1 as a function of molding (barrel) temperature. Composition 1 was analyzed due to the broad molding condition of the co-polycarbonate matrix used. 500 mg of sample (molded article) was dissolved in 5 mL of dichloromethane (DCM). Dissolution was aided by constant shaking for 2 hours. After the sample was completely dissolved, 20 mL acetonitrile (ACN) was added, and a precipitate formed. The mixture was then filtered twice, in different vials, and 25 μL of the filtered solution was injected into the HPLC. The polar mobile phase was a gradient of water and ACN.

The concentration of the dye in the sample was obtained by using a calibration curve obtained by plotting the concentration of PD-1 (2-20 ppm) and the total area of the HPLC signal.

Results presented in Table 8 demonstrate a correlation between temperature and dye degradation. Molding conditions at high temperature, such as for polycarbonates (290° C.-320° C.), led to undesired degradation of the photochromic dyes. Incorporation of soft-blocks into the polymer matrix, such as in compositions 1 and 3, was beneficial for lowering processing temperatures, and led to molded articles with less degraded dye and improved

TABLE 8

| | | Amount of | Amount of | |
|---|---|---|---|---|
| | Temperature | dye in | dye in molded | Loss of |
| Sample | (° C.) | pellets (ppm) | part (ppm) | dye (%) |
| Composition | 230 | 385.87 | 366.30 | −5.07 |
| 1 | 240 | | 353.46 | −8.40 |
| | 250 | | 345.86 | −10.37 |
| | 260 | | 340.86 | −11.66 |
| | 270 | | 328.61 | −14.84 |
| | 280 | | 295.88 | −23.32 |
| | 290 | | 263.80 | −31.63 |

For reasons of completeness, various aspects of the present disclosure are set out in the following numbered clauses:

Clause 1. An article comprising a thermoplastic composition comprising:

(a) a polycarbonate comprising
(i) structural units derived from:

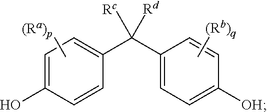

wherein R^{a} and R^{b} at each occurrence are each independently halogen, C₁-C₁₂ alkyl, C₁-C₁₂ alkenyl, C₃-C₈ cycloalkyl, or C₁-C₁₂ alkoxy; p and q at each occurrence are each independently 0 to 4; R^{c} and R^{d} are each independently hydrogen, halogen, alkyl, cycloalkyl, cycloalkylalkyl, aryl, arylalkyl, heterocyclyl, heterocyclylalkyl, heteroaryl, or heteroarylalkyl; and
(ii) structural units derived from at least one of:

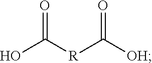

or a polydialkylsiloxane;
wherein R is C₄-C₁₈ alkyl; and

(b) a photochromic dye;

wherein the thermoplastic composition is a blend of the polycarbonate and the photochromic dye; wherein the total color shift rate of the article, ∂(dE), is at least 0.7 min⁻¹, at fifteen seconds after the article is subjected to 300 seconds of UV irradiation.

Clause 2. The article of clause 1, wherein the thermoplastic composition further comprises a poly(aliphatic ester)-polycarbonate copolymer of the formula:

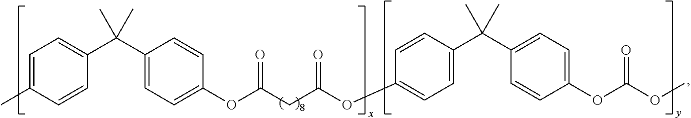

having a weight average molecular weight of 18,000 g/mol to 40,000 g/mol, as determined by gel permeation chromatography (GPC) using BPA polycarbonate standards; wherein x+y is 100.

Clause 3. The article of clause 1 or clause 2, wherein the polycarbonate comprises at least 50 mol % structural units derived from bisphenol A (BPA).

Clause 4. The article of any one of clauses 1-3, wherein the polycarbonate comprises structural units derived from polydimethylsiloxane.

Clause 5. The article of any one of clauses 1-4, wherein the polycarbonate comprises a polycarbonate-polydimethylsiloxane copolymer comprising from 3 wt % siloxane to 25 wt % siloxane.

Clause 6. The article of any one of clauses 1-5, wherein the polycarbonate comprises a polycarbonate-polydimethylsiloxane copolymer comprising from 3 wt % siloxane to 9 wt % siloxane.

Clause 7. The article of any one of clauses 1-6, wherein the polycarbonate is a PCP or phenol end-capped BPA polycarbonate-polydimethylsiloxane copolymer comprising 6 wt % siloxane, having a weight average molecular weight of 22,000 g/mol to 32.000 g/mol as determined by gel permeation chromatography (GPC) using BPA polycarbonate standards.

Clause 8. The article of any one of clauses 1-7, wherein the polycarbonate is a PCP end-capped BPA polycarbonate-polydimethylsiloxane copolymer comprising 6 wt % siloxane, produced by interfacial polymerization, having an average molecular weight of 23,000 g/mol, as determined by gel permeation chromatography (GPC) using BPA polycarbonate standards.

Clause 9. The article of any one of clauses 1-3, wherein the polycarbonate comprises structural units derived from

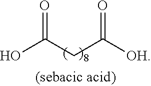

Clause 10. The article of any one of clauses 1-3 or 9, wherein the polycarbonate comprises a poly(aliphatic ester)-BPA polycarbonate copolymer comprising from 3 mol % sebacic acid to 8 mol % sebacic acid.

Clause 11. The article of any one of clauses 1-3 or 9-10, wherein the polycarbonate is a phenol or PCP end-capped poly(aliphatic ester)-BPA polycarbonate copolymer comprising 6 mol % sebacic acid, having an average molecular weight of 18,000 g/mol to 40,000 g/mol, as determined by gel permeation chromatography (GPC) using BPA polycarbonate standards.

Clause 12. The article of any one of clauses 1-3 or 9-11, wherein the polycarbonate is a PCP end-capped poly(aliphatic ester)-BPA polycarbonate copolymer comprising 6 mol % sebacic acid, having an average molecular weight of 21,000 g/mol, as determined by gel permeation chromatography (GPC) using BPA polycarbonate standards.

Clause 13. The article of any one of clauses 2-12, wherein the poly(aliphatic ester)-polycarbonate is a phenol or PCP end-capped poly(aliphatic ester)-BPA polycarbonate copolymer comprising 6 mol % sebacic acid copolymer, having a weight average molecular weight of 30,000 g/mol to 40,000 g/mol, as determined by gel permeation chromatography (GPC) using BPA polycarbonate standards.

Clause 14. The article of any one of clauses 2-13, wherein the poly(aliphatic ester)-polycarbonate is a PCP end-capped poly(aliphatic ester)-BPA polycarbonate copolymer comprising 6 mol % sebacic acid copolymer has a weight average molecular weight of 36,000 g/mol, as determined by gel permeation chromatography (GPC) using BPA polycarbonate standards.

Clause 15. The article of any one of clauses 1-14, wherein the thermoplastic composition further comprises a bisphenol-A polycarbonate.

Clause 16. An article comprising a thermoplastic composition comprising: (a) a bisphenol-A polycarbonate, wherein a molded article of the bisphenol-A polycarbonate has a transmission level greater than or equal to 90.0% at 2.5 mm thickness as measured by ASTM D1003-00 and a yellowness index (YI) less than or equal to 1.5 as measured by ASTM D1925-70(1988); and (b) a photochromic dye; wherein the thermoplastic composition is a blend of the polycarbonate and the photochromic dye; wherein the total color shift rate of the article, ∂(dE), is at least 0.7 min⁻¹, at fifteen seconds after the article is subjected to 300 seconds of UV irradiation.

Clause 17. The article of clause 16, wherein the bisphenol-A polycarbonate comprises less than or equal to 150 ppm free hydroxyl groups.

Clause 18. The article of clause 17 or clause 18, wherein the bisphenol-A polycarbonate comprises sulfur in an amount less than or equal to 2 ppm sulfur.

Clause 19. The article of any one of clauses 16-18, wherein a molded article of the bisphenol-A polycarbonate has an increase in yellow index (YI) of less than 2 during 2,000 hours of heat aging at 130° C.

Clause 20. The article of any one of clauses 16-19, wherein the bisphenol-A polycarbonate is produced by interfacial polymerization.

Clause 21. The article of any one of clauses 16-20, wherein the bisphenol-A polycarbonate is a phenol end-capped linear BPA polycarbonate produced by interfacial polymerization, having a weight average molecular weight of 21,800 g/mol as determined by GPC using BPA polycarbonate standards.

Clause 22. The article of any one of clauses 1-21, wherein the photochromic dye is a light-responsive organic compound that, upon irradiation with light at a wavelength of less than 650 nm, undergoes reversible intramolecular rearrangement, resulting in a color change of the article.

Clause 23. The article of any one of clauses 1-22, wherein the degradation level of the photochromic dye is less than 15% after molding the article at 270° C., as determined by the amount of residual dye in the molded article.

Clause 24. The article of any one of clauses 1-23, wherein the photochromic dye comprises a 2,1-b naphthoxazine.

Clause 25. The article of any one of clauses 1-23, wherein the photochromic dye comprises a 1,2-b naphthopyran.

Clause 26. The article of any one of clauses 1-25, wherein the composition comprises 0.05 wt % of the photochromic dye.

Clause 27. The article of any one of clauses 1-26, wherein the composition comprises

90 wt % to 99.6 wt % of the polycarbonate; 0.01 wt % to 0.5 wt % of the photochromic dye; and 0 to 10 wt % of the poly(aliphatic ester)-polycarbonate copolymer; provided that the combined wt % value of all components does not exceed 100 wt %.

Clause 28. The article of any one of clauses 1-8, 13-15, 22-24, 26 or 27, wherein the composition comprises: 99.62 wt % of a PCP end-capped BPA polycarbonate-polydimethylsiloxane copolymer comprising 6 wt % siloxane, produced by interfacial polymerization, having an average molecular weight of 23.000 g/mol, as determined by gel permeation chromatography (GPC) using BPA polycarbonate standards; 0.27 wt % of pentaerythritol tetrastearate (PET); 0.06 wt % of tris(di-t-butylphenyl)phosphite; and 0.05 wt % of a 2,1-b naphthoxazine dye.

Clause 29. The article of any one of clauses 1-8, 13-15, 22, 23 or 25-27, wherein the composition comprises: 99.62 wt % of a PCP end-capped BPA polycarbonate-polydimethylsiloxane copolymer comprising 6 wt % siloxane, produced by interfacial polymerization, having an average molecular weight of 23,000 g/mol, as determined by gel permeation chromatography (GPC) using BPA polycarbonate standards; 0.27 wt % of pentaerythritol tetrastearate (PET); 0.06 wt % of tris(di-t-butylphenyl)phosphite; and 0.05 wt % of a 1,2-b naphthopyran dye.

Clause 30. The article of any one of clauses 1-3, 9-15, 22-24, 26, or 27, wherein the composition comprises: 95.02 wt % of a PCP end-capped poly(aliphatic ester)-BPA polycarbonate copolymer comprising 6 mol % sebacic acid, having an average molecular weight of 21,000 g/mol, as determined by gel permeation chromatography (GPC) using BPA polycarbonate standards; 4.5 wt % of a PCP end-capped poly(aliphatic ester)-BPA polycarbonate copolymer comprising 6 mol % sebacic acid, having an average molecular weight of 36,000 g/mol, as determined by gel permeation chromatography (GPC) using BPA polycarbonate standards; 0.27 wt % of pentaerythritol tetrastearate (PET); 0.10 wt % of Joncryl ADR-4368-CS; 0.06 wt % of tris(di-t-butylphenyl)phosphite; and 0.05 wt % of a 2,1-b naphthoxazine dye.

Clause 31. The article of any one of clauses 1-8, 13-15, 22, 23 or 25-27, wherein the composition comprises: 95.02 wt % of a PCP end-capped poly(aliphatic ester)-BPA polycarbonate copolymer comprising 6 wt % sebacic acid, having an average molecular weight of 21,000 g/mol, as determined by gel permeation chromatography (GPC) using BPA polycarbonate standards; 4.5 wt % of a PCP end-capped poly(aliphatic ester)-BPA polycarbonate copolymer comprising 6 wt % sebacic acid, having an average molecular weight of 36,000 g/mol, as determined by gel permeation chromatography (GPC) using BPA polycarbonate standards; 0.27 wt % of pentaerythritol tetrastearate (PET); 0.10 wt % of Joncryl ADR-4368-CS; 0.06 wt % of tris(di-t-butylphenyl)phosphite; and 0.05 wt % of a 1,2-b naphthopyran dye.

Clause 32. The article of any one of clauses 1-31, wherein, the total color shift rate of the article, ∂(dE), is at least 2 min⁻¹, fifteen seconds after the article is subjected to 300 seconds of UV irradiation.

Clause 33. The article of any one of clauses 1-32, wherein the initial discoloration rate of the article, k₁, is at least 0.4 min⁻¹ after the article is subjected to 300 seconds of UV irradiation.

Clause 34. The article of any one of clauses 1-33, wherein, the initial discoloration rate of the article, k₁, is at least 0.6 min⁻¹ after the article is subjected to 300 seconds of UV irradiation.

Clause 35. The article of any one of clauses 1-34, selected from photochromic lens, sunglass lens, eyeglass lens, transition lens, window, glazing, auto glazing, sheet film, sheet, film, roofing or any combination thereof.

Clause 36. The article of any one of clauses 1-35, wherein the article is a sheet film.

Clause 37. The article of any one of clauses 1-35, wherein the article is a sunglass lens having a thickness of 1 mm to 2 mm.

Clause 38. The article of any one of clauses 1-35, wherein the article is a transition lens having a thickness of 1 mm to 2 mm.

Clause 39. The article of any one of clauses 1-35, wherein the article is a photochromic lens having a thickness of 1 mm to 2 mm.

Clause 40. The article of any one of clauses 1-35, wherein the article is an eyeglass lens having a thickness of 1 mm to 2 mm.

Clause 41. The article of any one of clauses 1-35, wherein the article is a window having a thickness of 4 mm to 6 mm.

Clause 42. The article of any one of clauses 1-35, wherein the article is an auto glazing having a thickness of 4 mm to 6 mm.

Clause 43. A method for producing the article of any one of clauses 1-35, the method comprising: (a) blending and homogenizing the polycarbonate and the photochromic dye to form a blend; (b) extruding the blend at 270° C.; and (c) injection molding the extruded blend at 270° C. or less to form the article.

Clause 44. The method of clause 43, wherein the article has a thickness of 1 mm to 2 mm.

Clause 45. The method of clause 43 or clause 44, wherein the degradation of the photochromic dye in the article is less than 15%, as determined by the amount of residual dye in the molded article.

Clause 46. A method for producing a sheet or film article, the method comprising compounding a photochromic dye and a polycarbonate to form a thermoplastic composition, and extruding the thermoplastic composition into a sheet or film at a temperature of 270° C. or less.

Clause 47. The method of clause 46, wherein the sheet or film has a thickness of 4 mm to 6 mm.

Clause 48. The method of clause 46 or clause 47, wherein the sheet or film is a multilayer sheet.

Clause 49. The method of any one of clauses 46-48, wherein the degradation of the photochromic dye in the article is less than 15%, as determined by the amount of residual dye in the sheet or film.

Clause 50. The article of any one of clauses 1-42, wherein the thermoplastic composition does not comprise glass fibers.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims. The appended claims should be construed broadly and in a manner consistent with the spirit and the scope of the invention herein.

What is claimed is:

1. An article comprising a thermoplastic composition comprising:
(a) a polycarbonate that includes
(i) structural units derived from: 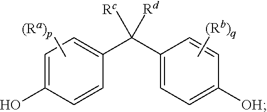
wherein R^{a} and R^{b} at each occurrence are each independently halogen, C₁-C₁₂ alkyl, C₁-C₁₂ alkenyl, C₃-C₈ cycloalkyl, or C₁-C₁₂ alkoxy; p and q at each occurrence are each independently 0 to 4; R^{c} and R^{d} are each independently hydrogen, halogen, alkyl, cycloalkyl, cycloalkylalkyl, aryl, arylalkyl, heterocyclyl, heterocyclylalkyl, heteroaryl, or heteroarylalkyl; and
(ii) structural units derived from at least one of: 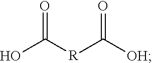
or a polydialkylsiloxane;
wherein R is C₄-C₁₈ alkyl; and
(b) a photochromic dye;
wherein the thermoplastic composition is a blend of the polycarbonate and the photochromic dye; wherein the total color shift rate of the article, ∂(dE), is at least 0.7 min⁻¹, at fifteen seconds after the article is subjected to 300 seconds of UV irradiation.

2. The article of claim 1, wherein the thermoplastic composition comprises a poly(aliphatic ester)-polycarbonate copolymer of the formula: 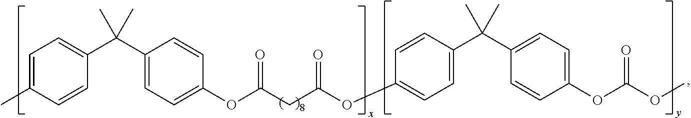
having a weight average molecular weight of about 18,000 g/mol to about 40,000 g/mol, as determined by gel permeation chromatography (GPC) using BPA polycarbonate standards; wherein x+y is 100.

3. The article of claim 1, wherein the polycarbonate comprises at least 50 mol % structural units derived from bisphenol A (BPA).

4. The article of claim 1, wherein the polycarbonate comprises a polycarbonate-polydimethylsiloxane copolymer comprising from about 3 wt % siloxane to about 9 wt % siloxane.

5. The article of claim 1, wherein the polycarbonate is a PCP end-capped BPA polycarbonate-polydimethylsiloxane copolymer comprising about 6 wt % siloxane, produced by interfacial polymerization, having an average molecular weight of about 23,000 g/mol, as determined by gel permeation chromatography (GPC) using BPA polycarbonate standards.

6. The article of claim 1, wherein the polycarbonate comprises a poly(aliphatic ester)-BPA polycarbonate copolymer comprising from about 3 mol % sebacic acid to about 8 mol % sebacic acid.

7. The article of claim 1, wherein the polycarbonate is a PCP end-capped poly(aliphatic ester)-BPA polycarbonate copolymer comprising about 6 mol % sebacic acid, having an average molecular weight of about 21,000 g/mol, as determined by gel permeation chromatography (GPC) using BPA polycarbonate standards.

8. The article of claim 2, wherein the poly(aliphatic ester)-polycarbonate is a phenol or PCP end-capped poly(aliphatic ester)-BPA polycarbonate copolymer comprising about 6 mol % sebacic acid copolymer, having a weight average molecular weight of about 30,000 g/mol to about 40,000 g/mol, as determined by gel permeation chromatography (GPC) using BPA polycarbonate standards.

9. An article comprising a thermoplastic composition comprising:
(a) a bisphenol-A polycarbonate, wherein a molded article of the bisphenol-A polycarbonate has transmission level greater than or equal to 90.0% at 2.5 mm thickness as measured by ASTM D1003-00 and a yellow index (YI) less than or equal to 1.5 as measured by ASTM D1925; and
(b) a photochromic dye;
wherein the thermoplastic composition is a blend of the polycarbonate and the photochromic dye; wherein the total color shift rate of the article, ∂(dE), is at least 0.7 min⁻¹, at fifteen seconds after the article is subjected to 300 seconds of UV irradiation.

10. The article of claim 1, wherein the degradation level of the photochromic dye is less than 15% after molding the article at 270° C., as determined by the amount of residual dye in the molded article.

11. The article of claim 1, wherein the photochromic dye comprises a 2,1-b naphthoxazine.

12. The article of claim 1, wherein the photochromic dye comprises a 1,2-b naphthopyran.

13. The article of claim 1, wherein the composition comprises 0.05 wt % of the photochromic dye.

14. The article of claim 1, wherein the composition comprises
about 90 wt % to about 99.6 wt % of the polycarbonate;
about 0.01 wt % to about 0.5 wt % of the photochromic dye;
0 to about 10 wt % of the poly(aliphatic ester)-polycarbonate copolymer;
provided that the combined wt % value of all components does not exceed 100 wt %.

15. The article of claim 1, wherein, the total color shift rate of the article, ∂(dE), is at least 2 min⁻¹, fifteen seconds after the article is subjected to 300 seconds of UV irradiation.

16. The article of claim 1, selected from photochromic lens, sunglass lens, eyeglass lens, transition lens, window, glazing, auto glazing, sheet film, sheet, film, roofing or any combination thereof.

17. A method for producing the article of claim 1, the method comprising
a) blending and homogenizing the polycarbonate and the photochromic dye to form a blend;
b) extruding the blend at 270° C.; and
c) injection molding the extruded blend at 270° C. or less to form the article.

18. The method of claim 17, wherein the degradation of the photochromic dye in the article is less than 15%, as determined by the amount of residual dye in the molded article.

19. A method for producing a sheet or film article, the method comprising compounding a photochromic dye and a polycarbonate to form a thermoplastic composition, and extruding the thermoplastic composition into a sheet or film at a temperature of 270° C. or less.

20. The article of claim 1, wherein the thermoplastic composition does not comprise glass fibers.
